(19) United States
(12) Patent Application Publication
(10) Pub. No.: US 2006/0065861 A1
(43) Pub. Date: Mar. 30, 2006

(54) Radiation image storage panel

(75) Inventor: Seiji Tazaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/215,011

(22) Filed: Aug. 31, 2005

(30) Foreign Application Priority Data
Sep. 29, 2004 (JP) 2004-285373

(51) Int. Cl. G21K 4/00

(52) U.S. Cl. 250/580

(57) ABSTRACT

In a radiation image storage panel composed of a support, a sealing frame provided on a surface of the support in its peripheral area, a phosphor layer formed inside the sealing frame, and a moisture-proof protective film provided on the phosphor layer and sealing frame, a reinforcement means is fixed onto a upper surface of the moisture-proof protective film at least in the area where the protective film covers the sealing frame.

### FIELD OF THE INVENTION

The present invention relates to a radiation image storage panel employable in a radiation image recording and reproducing method utilizing an energy-storing phosphor.

### BACKGROUND OF THE INVENTION

When exposed to radiation such as X-rays, an energy-storing phosphor (e.g., stimulable phosphor, which gives off stimulated emission) absorbs and stores a portion of the radiation energy. The phosphor then emits stimulated emission according to the level of the stored energy when exposed to electromagnetic wave such as visible or infra-red light (i.e., stimulating light). A radiation image recording and reproducing method utilizing the energy-storing phosphor has been widely employed in practice. In that method, a radiation image storage panel, which is a sheet comprising the energy-storing phosphor, is used. The method comprises the steps of: exposing the storage panel to radiation having passed through an object or having radiated from an object, whereby radiation image information of the object is temporarily recorded in the storage panel; sequentially scanning the storage panel with a stimulating light such as a laser beam to emit stimulated light; and photoelectrically detecting the emitted light to obtain electric image signals. The storage panel thus treated is subjected to a step for erasing radiation energy remaining therein, and then stored for the use in the next recording and reproducing procedure. Thus, the radiation image storage panel can be repeatedly used.

The radiation image storage panel (often referred to as stimulable phosphor sheet) has a basic structure comprising a support and an energy-storing phosphor layer provided thereon. However, if the phosphor layer is self-supporting, the support can be omitted. Further, a protective film is normally provided on the free surface (surface not facing the support) of the phosphor layer to keep the phosphor layer from chemical deterioration or physical damage.

Various kinds of energy-storing phosphor layers are known. For example, the phosphor layer can comprise a binder and energy-storing phosphor particles dispersed therein, or otherwise can comprise columnar crystals of energy-storing phosphor without binder. The latter can be formed by a gas phase-accumulation method, in which the phosphor or material thereof is vaporized (or sputtered) and accumulated on a substrate to prepare a layer of the phosphor in the form of columnar crystals. The thus-prepared phosphor layer consists of only the phosphor, and there are gaps among the columnar crystals of phosphor. Accordingly, the stimulating light can be applied efficiently and the emission can be efficiently collected to improve the sensitivity. In addition, since the stimulating light is kept from scattering horizontally, an image of high sharpness can be obtained.

The radiation image recording and reproducing method (or radiation image forming method) has various advantages as described above. However, it is still desired that the radiation image storage panel used in the method have as high sensitivity as possible and, at the same time, give a reproduced radiation image of as high quality (in regard to sharpness and graininess) as possible.

As for the phosphor, if the phosphor is hygroscopic and the hygroscopic moisture is liable to impair characteristics (for example, in regard to emission) of the storage panel utilizing the phosphor, it is desired that the phosphor layer be so tightly sealed as to isolate completely from the surrounding atmosphere. In fact, it is known that the phosphor layer can be sealed tightly using a support, a protective film and other sealing members.

The applicant has already proposed a sealed radiation image storage panel (U.S. Ser. No. 11/094,213). The proposed panel comprises a substrate (support), a stimulable phosphor layer formed by the vacuum film-forming process, a moisture-proof protective layer sealing the phosphor layer, and a sealing adhesive layer with which the protective layer is glued on the margin. The sealing adhesive layer comprises an adhesive agent having a moisture permeability of 1,000 g/m²·day or less after hardened, and has a width of 2 to 10 mm and a thickness of 0.5 to 20 μm. The hem of the protective layer may be glued via the adhesive layer either directly on the substrate, or on a sealing member (sealing frame) provided around the phosphor layer on the substrate. The protective layer glued via the sealing adhesive layer is expected to prevent moisture from penetrating into the phosphor layer.

The applicant has further studied a radiation image storage panel having a sealing structure, and found that the hem of the protective film, namely, the protective film in the area where the layer is fixed via the adhesive layer on the support or on a sealing frame (that is, in the sealing area) often peels off. In the storage panel of sealing structure, the adhesive layer is made as thin as possible in order not to impair image-forming characteristics of the phosphor layer. As a result, the adhesive layer is liable to have poor peel strength. Accordingly, it is a problem that the protective film in the sealing area has poor peeling strength. Further, in producing the storage panel having the sealing structure, a gap is normally formed between the phosphor layer and the protective film or between the phosphor layer and the sealing frame. It has been also found that the protective film in the area covering the gap often breaks.

### SUMMARY OF THE INVENTION

It is an object of the present invention to provide a high-quality radiation image storage panel keeping improved durability for a long time.

The applicant has studied the above problem, and found that a reinforcement means provided on the sealing area can prevent the hem of the protective film from peeling off and thereby can prevent the protective film from breaking.

The present invention resides in a radiation image storage panel comprising a support, a sealing frame provided on a surface of the support in a peripheral area thereof, a phosphor layer formed inside the sealing frame, and a moisture-proof protective film provided on the phosphor layer and sealing frame, wherein a reinforcement means is fixed onto a upper surface of the moisture-proof protective film at least in the area where the protective film covers the sealing frame.

The invention also resides in a radiation image storage panel comprising a support, a phosphor layer provided thereon and in an area other than a peripheral area of the support, and a moisture-proof protective film covering the phosphor layer whose hem is fixed via an adhesive layer onto the support in the peripheral area; wherein a reinforcement means is fixed onto a upper surface of the moisture-proof protective film at least in the area where the protective film covers the peripheral area.

The radiation image storage panel of the invention has such high durability that the moisture-proof protective film neither peels off nor breaks even if the storage panel is repeatedly used for a long time. Accordingly, the phosphor layer can be kept sealed tightly enough to ensure high quality. The radiation image storage panel of the invention, therefore, can be advantageously used for a long time, for example, in medical diagnoses.

### BRIEF DESCRIPTION OF DRAWINGS

FIG. 1 is a sectional view schematically illustrating an example of the constitution of radiation image storage panel according to the invention.

FIG. 2 is an enlarged and detailed partial view of FIG. 1.

FIG. 3 is a partial sectional view schematically illustrating another example of the reinforcement provided on the panel.

FIG. 4 is a partial sectional view schematically illustrating yet another example of the reinforcement provided on the panel.

FIG. 5 is a partial sectional view schematically illustrating still another example of the reinforcement provided on the panel.

FIG. 6 is a sectional view schematically illustrating another example of the constitution of radiation image storage panel according to the invention.

FIG. 7 is an enlarged and detailed partial view of FIG. 6.

FIG. 8 is a partial sectional view schematically illustrating still yet another example of the reinforcement provided on the panel.

FIG. 9 is a sectional view schematically illustrating the constitution of radiation image storage panel produced in Example 1.

FIG. 10 is a top view schematically illustrating the radiation image storage panel shown in FIG. 9.

### DETAILED DESCRIPTION OF THE INVENTION

In the radiation image storage panel of the invention, there may be a gap between the phosphor layer and the protective film or between the phosphor layer and the sealing frame. In that case, the reinforcement means is preferably glued in the peripheral area on the surface of the moisture-proof protective film in the area corresponding to both the sealing frame and the gap.

The reinforcement means is preferably made of material that is more rigid than material of the moisture-proof protective film. More preferably, the reinforcement means is made of the same material as the material of sealing frame and/or the support. The reinforcement means is preferably made of metal.

In the following description, the radiation image storage panel of the invention is explained in detail with reference to the attached drawings.

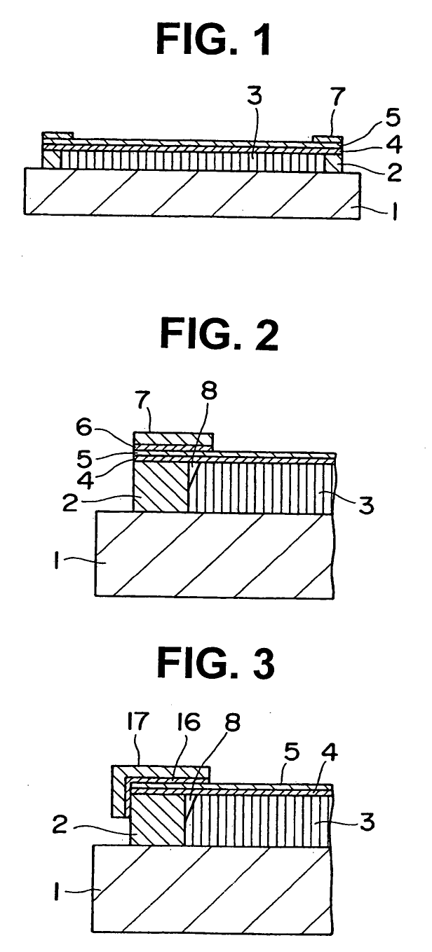

FIG. 1 is a sectional view schematically illustrating an example of the constitution of radiation image storage panel according to the invention, and FIG. 2 is an enlarged and detailed partial view of FIG. 1. In FIGS. 1 and 2, the storage panel comprises a support 1, a sealing frame 2 fixed on the surface of the support 1 in a peripheral area, a phosphor layer 3 formed inside the sealing frame 2, a first adhesive layer 4, a moisture-proof protective film 5, a second adhesive layer 6 and a reinforcement means 7. The moisture-proof protective film 5 is glued with the first adhesive layer 4 on the whole top surfaces of both the sealing frame 2 and the phosphor layer 3, so as to cover and seal closely the phosphor layer 3.

In the invention, the reinforcement means 7 is the form of frame provided via the second adhesive layer 6 on the surface of the moisture-proof protective film 5 in the peripheral area, so as to cover the area corresponding to the sealing frame 2 (sealing area) of the protective film 5 and the gap 8. The gap 8 is often formed in producing the storage panel.

For the purpose of reinforcing the moisture-proof protective film, the reinforcement means 7 is preferably made of material that is more rigid than material of the protective film. Therefore, the protective film can have improved peel strength and, even if the film peels from the edge, the separation angle would be beyond 90°. The reinforcement means 7 and the sealing frame 2 are preferably made of the same material, and more preferably the reinforcement means 7, the sealing frame 2 and the support 1 are made of the same material. Under such condition, they have the same thermal expansion coefficient, and the storage panel equipped with the reinforcement means is hardly deformed even if the surrounding temperature extremely changes. Examples of reinforcing-materials for the reinforcement means include metals such as aluminum, iron, copper, tin, chromium and magnesium; and resins such as polyimide. Preferred are metals, and particularly preferred are aluminum and aluminum alloys.

The reinforcement means 7 is provided at least in the area corresponding to the sealing frame 2, preferably in the area corresponding to both the sealing frame 2 and the gap 8, as shown in FIG. 2. Accordingly, the width of the reinforcement means depends on the sizes of the sealing frame and the gap, but is generally in the range of 3 to 15 mm. The thickness of the reinforcement generally is in the range of 0.2 to 2 mm.

The reinforcement means 7 is provided on the protective film 5 in the area corresponding to the sealing frame 2, and thereby the sealing area is physically reinforced to prevent the hem of the protective film from peeling off. In a radiation image storage panel without the reinforcement means, peeling force is linearly applied to accelerate separation of the phosphor layer. In contrast, in the storage panel equipped with the reinforcement means, the applied force is so dispersed in the planar directions that the phosphor layer is hardly separated. Further, as shown in FIG. 2, the reinforcement means 7 provided also in the area corresponding to the gap 8 can prevent the phosphor layer from braking on the gap.

FIGS. 3, 4 and 5 are partial sectional views schematically illustrating other examples of the reinforcement means provided on the panel of the invention.

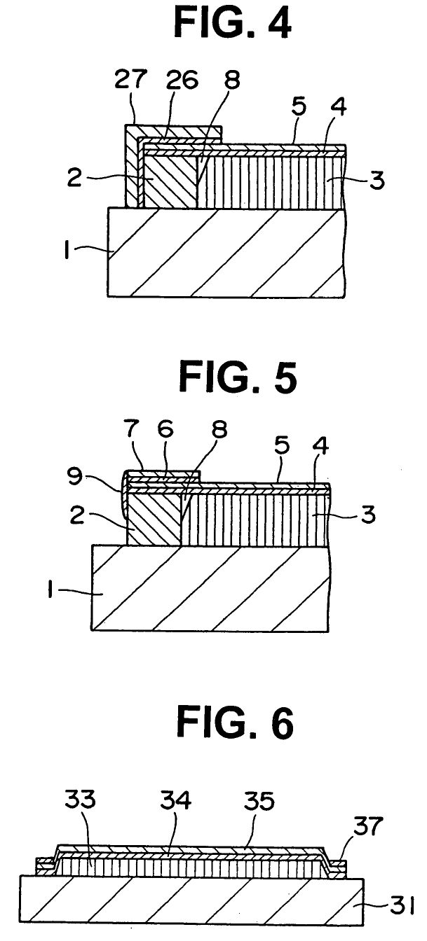

In FIG. 3, a reinforcement means 17 in the shape of rectangularly hooked frame is provided via a second adhesive layer 16 to cover not only the top surface of the protective film 5 but also the side surface thereof and, further, a part of the side surface of the sealing frame 2. In FIG. 4, a reinforcement means 27 in the shape of rectangularly hooked frame is provided via a second adhesive layer 26 to cover not only the top surface of the protective film 5 but also the side surface thereof and the whole side surface of the sealing frame 2. The reinforcement means thus provided can enhance not only the peel strength but also the moisture proof in the sealing area.

In FIG. 5, a sealant 9 of adhesive is further provided around the storage panel, so as to cover the side surfaces of the sealing frame 2 to the reinforcement means 7. The adhesive of the sealant 9 can be the same as the resin used in the second adhesive layer 6, and the sealant 9 can be easily formed to prevent more efficiently the layer in the sealing area from peeling off.

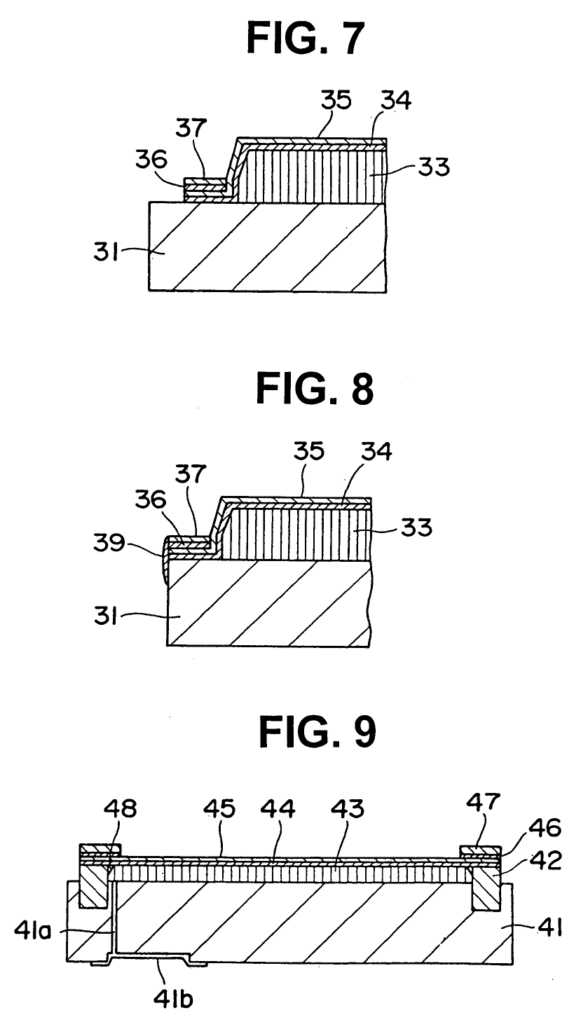

FIG. 6 is a sectional view schematically illustrating another example of the constitution of radiation image storage panel according to the invention, and FIG. 7 is an enlarged and detailed partial view of FIG. 6. In FIGS. 6 and 7, the storage panel comprises a support 31, a phosphor layer 33, a first adhesive layer 34, a moisture-proof protective film 35, a second adhesive layer 36 and a reinforcement means 37. The moisture-proof protective film 35 is glued both-on the top surface of the phosphor layer 33 and directly on the marginal top surface of the support with the first adhesive layer 34, so as to cover and seal closely the phosphor layer 33. The reinforcement means 37 is in the form of frame which is provided via the second adhesive layer 36 on the surface of the moisture-proof protective film 35 in the peripheral area, so as to cover the area where the protective film 35 is glued on the support.

The reinforcement means 37 in FIG. 6 is placed only on the area where the protective film is glued on the support, but it can be also provided on the side surface of the protective film 35. If there is a gap between the phosphor layer 33 and the protective film 35, the reinforcement means an be provided thereon to cover the gap.

FIG. 8 is a partial sectional view schematically illustrating still another example of the reinforcement means provided on the panel of the invention. In FIG. 8, a sealant 39 of adhesive is further provided around the panel, so as to cover the side surfaces of the support 31 to the reinforcement 37.

The radiation image storage panel of the invention is by no means restricted to those of the attached drawings, and can have various other auxiliary layers and/or can be subjected to various treatments as described later.

In the following description, the process for preparation of the radiation image storage panel of the invention is explained in detail, by way of example, in the case where the phosphor is an energy-storing phosphor and where the phosphor layer is formed by a gas phase-accumulation method such as vapor deposition.

The substrate on which the accumulated phosphor layer is to be formed is generally used as a support of the storage panel, and hence can be optionally selected from known materials conventionally used as a support of storage panel. The substrate preferably is a plate of glass (e.g., quartz glass, alkali-free glass, soda glass, heat resisting glass), a sheet of metal (e.g., aluminum, iron, copper, tin, chromium), or a sheet of plastic material (e.g., polyimide, cellulose acetate, polyester, polyethylene terephthalate, polyamide, triacetate, polycarbonate).

On the bottom (back) surface (on which the phosphor layer is not formed) of the substrate, a shallow concavity for air-buffer and an airway penetrating through the substrate can be provided (see, FIG. 9). The phosphor layer formed by the gas phase-accumulation method holds air (in the amount of approx. 20%) among the columnar crystals of the phosphor. Because of the air, the phosphor layer is liable to come off when the atmospheric pressure changes to cause difference between the inner and outer pressures (for example, when the storage panel is used in the highlands). The concavity (which is to be covered later with a slacked laminate film) and the airway can avoid this problem.

As shown in FIG. 1, the sealing frame can be placed on the top surface of the substrate. The sealing frame makes it easy to seal the phosphor layer tightly, and protects the phosphor layer when the moisture-proof protective film is provided thereon. The shape, width and thickness of the sealing frame are optionally determined. The width of the sealing frame generally is in the range of 2 to 10 mm. There is no particular restriction on material of the sealing frame. However, in order to avoid thermal deformation, the sealing frame is preferably made of material having almost the same thermal expansion coefficient as that of the substrate (the difference between them is preferably less than 1.0×10⁻⁶/° C.). More preferably, the sealing frame is made of the same material as the substrate. The sealing frame is fixed onto the substrate with adhesive, preferably with heat resisting adhesive such as epoxy adhesive (which can be heat-resistant at 150° C. or higher), or otherwise with melting metal such as aluminum solder.

For installing the sealing frame, the frame is positioned with a proper jig and then fixed onto the substrate. Otherwise, the frame can be also installed by the steps of: machining the substrate to form a groove corresponding to the shape of the sealing frame, and fitting and fixing the frame in the groove. In the latter case, the depth of the groove generally is in the range of 0.2 to 5 mm. By providing the groove on the substrate, the sealing frame and the phosphor layer can be precisely positioned. Further, since the frame can be made thick (in consideration of the depth of the groove), the mechanical strength and dimensional precision of the frame can be ensured and, at the same time, the production of the storage panel can be easily carried out.

The top surface of the sealing frame thus-installed on the substrate is masked with a releasable masking sheet (tape) having enough flexibility to expand according to the thermal expansion of the frame, and then the phosphor layer is formed on the substrate.

In the case where the sealing frame is not provided on the substrate, the peripheral area of the surface of the substrate is masked with the above masking sheet (tape), and then the phosphor layer is formed on the substrate. The width of the masked area is determined in consideration of the area where the phosphor layer is to be formed.

Before forming the phosphor layer, a light-reflecting layer containing a light-reflecting material such as titanium dioxide or a light-absorbing layer containing a light-absorbing material such as carbon black can be formed on the substrate for improving the sensitivity or the image quality (e.g., sharpness and graininess). Further, in order to promote growth of the columnar crystals, a great number of very small convexes or concaves may be provided on the substrate surface (or on the above auxiliary layer) on which the accumulated phosphor layer is to be formed.

The energy-storing phosphor is preferably a stimulable phosphor giving off stimulated emission in the wavelength region of 300 to 500 nm when exposed to a stimulating light in the wavelength region of 400 to 900 nm.

Particularly preferred is an alkali metal halide stimulable phosphor represented by the following formula (I):
M^{I}X.aM^{II}X′₂.bM^{III}X″₃: zA (I)
in which M^{I} is at least one alkali metal selected from the group consisting of Li, Na, K, Rb and Cs; M^{II} is at least one alkaline earth metal or divalent metal selected from the group consisting of Be, Mg, Ca, Sr, Ba, Ni, Cu, Zn and Cd; M^{III} is at least one rare earth element or trivalent metal selected from the group consisting of Sc, Y, La, Ce, Pr, Nd, Pm, Sm, Eu, Gd, Tb, Dy, Ho, Er, Tm, Yb, Lu, Al, Ga and In; A is at least one rare earth element or metal selected from the group consisting of Y, Ce, Pr, Nd, Sm, Eu, Gd, Tb, Dy, Ho, Er, Tm, Yb, Lu, Mg, Cu and Bi; each of X, X′ and X″ is independently at least one halogen selected from the group consisting of F, Cl, Br and I; and a, b and z are numbers satisfying the conditions of 0≦a<0.5, 0≦b<0.5 and 0<z<1.0, respectively.

It is also preferred to use a rare earth activated alkaline earth metal fluoride halide stimulable phosphor represented by the following formula (II):
M^{II}FX:zLn (II)
in which M^{II} is at least one alkaline earth metal selected from the group consisting of Ba, Sr and Ca; Ln is at least one rare earth element selected from the group consisting of Ce, Pr, Sm, Eu, Tb, Dy, Ho, Nd, Er, Tm and Yb; X is at least one halogen selected from the group consisting of Cl, Br and I; and z is a number satisfying the condition of 0<z≦0.2.

Still also preferred is a rare earth activated alkaline earth metal sulfide stimulable phosphor represented by the following formula (III):
M^{II}S:A,Sm (II)
in which M^{II} is at least one alkaline earth metal selected from the group consisting of Mg, Ca and Sr; and A is preferably Eu and/or Ce.

Further, yet another preferred phosphor is a cerium activated trivalent metal oxide halide stimulable phosphor represented by the following formula (IV):
M^{III}OX:Ce (IV)
in which M^{III} is at least one rare earth element or trivalent metal selected from the group consisting of Pr, Nd, Pm, Sm, Eu, Tb, Dy, Ho, Er, Tm, Yb and Bi; and X is at least one halogen selected from the group consisting of Cl, Br and I.

The phosphor in the invention is not restricted to an energy-storing phosphor. It may be a phosphor absorbing radiation such as X-rays and instantly giving off (instant) emission in the ultraviolet or visible resin. Examples of these phosphors include phosphors of LnTaO₄: (Nb,Gd) type, Ln₂SiO₅:Ce type and LnOX:Tm type (Ln is a rare earth element); CsX (X is a halogen) type; Gd₂O₂S:Tb; Gd₂O₂S:Pr,Ce; ZnWO₄; LuAlO₃:Ce; Gd₃Ga₅O₁₂:Cr,Ce; and HfO₂.

Examples of the gas phase-accumulation methods include: a vapor deposition method with a resistance heater or with an electron beam, a sputtering method, and a chemical vapor deposition (CVD) method. For example, according to the vapor deposition method, a layer of deposited phosphor can be formed from an evaporation source by a single deposition process or from two or more evaporation sources by a multi-vapor deposition (co-deposition) process. The evaporation source comprises the energy-storing phosphor or materials for preparing the energy-storing phosphor. The vapor deposition process comprises the steps of: heating to vaporize one or more evaporation sources by means of a resistance heater or an electron beam, and depositing and accumulating the vapor on a substrate to form a phosphor layer. In the process, the vacuum evaporation-deposition apparatus is evacuated to give a medium vacuum of 0.1 to 10 Pa or a high vacuum of 1×10⁻⁵ to 1×10⁻² Pa. During the deposition procedure, the substrate may be heated or cooled. The temperature of the substrate generally is in the range of 20 to 350° C., preferably in the range of 100 to 300° C. The deposition rate, which means how fast the phosphor is deposited and accumulated on the substrate, generally is in the range of 0.1 to 1,000 μm/min., preferably in the range of 1 to 100 μm/min.

The vapor-deposition procedure can be repeated twice or more to form a phosphor layer consisting of two or more sub-layers. After the deposition procedure is complete, the formed layer can be subjected to heat treatment (annealing).

The formed phosphor layer consists of phosphor in the form of columnar structure grown almost in the thickness direction. The phosphor layer consists of only the phosphor, and there are gaps among the columnar structure. The thickness of the phosphor layer generally is in the range of 50 μm to 1 mm, preferably 200 μm to 700 μm.

The invention is not restricted to the gas phase-accumulation method, and other known methods may be adopted to form the phosphor layer. For example, a phosphor layer comprising a binder and energy-storing phosphor particles dispersed therein can be formed by the coating process.

After the phosphor layer is formed, the masking sheet (tape) is removed from the sealing frame or from the peripheral area of the substrate. In this way, the phosphor layer can be formed only inside the sealing frame or in the aimed area of the substrate.

On the phosphor layer, the moisture-proof protective film is provided to seal tightly the phosphor layer so that hygroscopic moisture may not impair characteristics of the storage panel. The protective film also keeps the phosphor layer from chemical deterioration or physical damage, and accordingly it is preferred that the film is chemically stable and physically strong. Further, the protective film preferably is transparent so as not to prevent the stimulating rays from coming in or not to prevent the emission from coming out.

The moisture-proof protective film has a moisture permeability of preferably 1 g/m²·day or less, more preferably 0.2 g/m²·day or less. The protective film is, for example, a transparent glass plate, a film of transparent resin such as polyethylene terephthalate or polycarbonate, or a transparent resin film on which a thin layer of inorganic substance is formed. Examples of the inorganic substance include SiO₂, Al₂O₃ and SiC. The inorganic substance layer can be formed by the vacuum accumulation method such as a vapor-deposition process or by the coating method such as a sol-gel process. The inorganic layer may consist of a single layer or plural sub-layers. In the case where the layer consists of two or more sublayers, the sub-layers may be made of either different materials or the same material. The thickness of the protective film is generally in the range of about 1 to 10 μm (preferably, about 2 to 7 μm) if the protective film is a transparent resin film or one laminated with an inorganic substance film, or otherwise is in the range of about 100 to 1,000 μm if the protective film is a glass plate.

The moisture-proof protective film is glued with the adhesive layer to fix onto the top surface of the sealing frame or in the peripheral area of the support, so that the phosphor layer is tightly sealed. In consideration of durability, the protective film is also glued on the surface of the phosphor layer. For installing the protective film, for example, first an adhesive layer is formed by the coating method on (the whole or a part of) one surface of the protective film, and then the film is placed on the phosphor layer beforehand provided on the support (i.e., substrate) so that the adhesive layer may be placed between the protective film and the support. The obtained laminate is heated and pressed to fix the protective film onto the sealing frame or on the support and, if needed, on the phosphor layer. Examples of resins for the adhesive layer include polyester resin, polyacrylic resin, and epoxy resin. If the protective film is to be glued only on the support, the width of the adhesive layer is generally in the range of 2 to 10 mm. The adhesive layer generally has a thickness of 0.5 to 20 μm.

In the steps (such as masking and lamination) for producing the storage panel having the above-described structure (in which the phosphor layer is sealed with the support, the protective film and, optionally, the sealing frame), a gap is often formed between the phosphor layer and the protective film or between the phosphor layer and the sealing frame.

In the peripheral area of the surface of the moisture-proof protective film, the reinforcement means is placed, as described above. The aforementioned reinforcing material is, for example, machined to form a reinforcement means in the predetermined frame shape (flat frame or rectangularly hooked frame). The shape and width of the reinforcement can be determined according to various conditions such as the shapes of the sealing frame and the support. The frame-shaped reinforcement means is fixed with a proper adhesive onto the surface of the moisture-proof protective film.

Thus, the radiation image storage panel of the invention can be produced. The radiation image storage panel of the invention can be in known various structures. For example, in order to improve the sharpness of the resultant image, at least one of the layers can be colored with a colorant which absorbs the stimulating ray and/or the stimulated emission. In that case, the adhesive layer is preferably colored because it can be easily colored without impairing other characteristics.

### EXAMPLE 1

(1) Support

As the support, a substrate (size: 450 mm×450 mm, thickness: 10 mm) of aluminum alloy is prepared. The substrate was machined to form a shallow concavity (size: 110 mm×110 mm, depth: 2 mm) on the bottom surface at a marginal place 10 mm from the edge, and also to bore a penetrating airway (diameter: 1 mm) in the corner (16 mm from both side edge).

(2) Sealing

The substrate was further machined to form a frame-shaped groove (frame size: 430 mm×430 mm, width: 5 mm, depth: 1.3 mm). In the groove, a frame (size: 429.9 mm×429.9 mm, width: 4.8 mm, thickness: 2 mm) made of the same aluminum alloy as the substrate was fitted and fixed with heat resisting epoxy adhesive, to install a sealing frame. On the top surface of the sealing frame, a polyimide tape coated with heat resisting adhesive was glued. The surplus tape, which spread out of the top surface of the sealing frame, was clipped off to mask the surface.

(3) Phosphor Layer

As the evaporation sources, powdery cesium bromide (CsBr) and powdery europium bromide (EuBr₂) were prepared. The masked substrate and the two evaporation sources were placed at the predetermined positions in an evaporation-deposition apparatus. The apparatus was then evacuated to make the inner pressure 1×10⁻³ Pa, and successively Ar gas was introduced to set the inner pressure at 1.0 Pa. The substrate was then heated to 100° C., and the evaporation sources were heated and melted by means of resistance heaters, so that CsBr:Eu stimulable phosphor was deposited and accumulated at the rate of 10 μm/min. to form a phosphor layer (thickness: 710 μm). After the deposition was complete, the polyimide masking tape was peeled off to leave the phosphor layer only inside the sealing frame. The substrate was then subjected to heating treatment at 200° C. for 2 hours.

(4) Moisture-Proof Protective Film

On a polyethylene terephthalate (PET) film (base film, thickness: 6 μm), a SiO₂ layer (thickness: 100 nm), a hybrid layer of SiO₂/polyvinyl alcohol (PVA) (SiO₂:PVA=1:1 [by weight], thickness: 600 nm) and another SiO₂ layer (thickness: 100 nm) were successively formed by sputtering process, sol-gel process and sputtering process, respectively. Thus, a three-layered moisture-proof protective sheet comprising the inorganic substance layers was prepared. On the inorganic substance layer-side surface of the sheet, a solution of polyester resin was coated and dried to form an adhesive layer (thickness: 1.2 μm). The substrate subjected to the heating treatment was preheated at 100° C., and then the protective sheet was placed thereon so that the adhesive layer was in contact with the phosphor layer. The obtained laminate was heated to glue the sheet both on the phosphor layer and on the sealing frame. In this way, a moisture-proof protective film was provided.

(5) Air-Buffer

The margin of an aluminum foil-laminated film (size: 130 mm×130 mm) was coated with an acrylic adhesive (thickness: 25 μm, width: 10 mm). The film was then stuck over the concavity formed on the bottom surface. In sticking the film, the film was slacked so as to hang loose down in the concavity. Thus, an air-buffer was formed.

(6) Reinforcement Means

As a reinforcement means, a frame (size: 429.9 mm×429.9 mm, width: 6 mm, thickness: 0.6 mm) made of the same aluminum alloy as the substrate was prepared. A thin double-sided adhesive tape was stuck on one surface of the frame, and then the frame was glued on the protective film in an area corresponding to the sealing frame. Thus, a radiation image storage panel of the invention was produced.

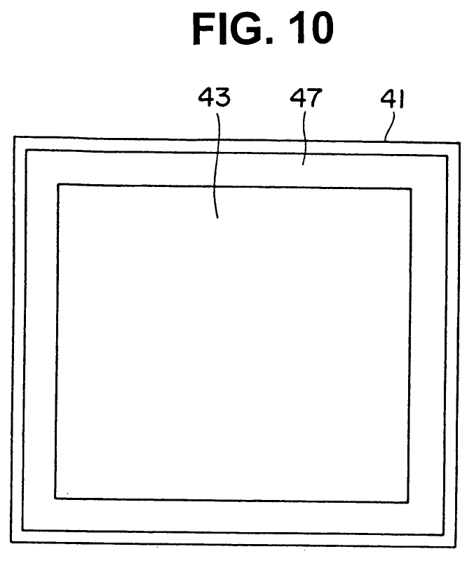

FIG. 9 is a sectional view schematically illustrating the radiation image storage panel produced in Example 1, and FIG. 10 is a top view schematically illustrating the storage panel shown in FIG. 9. In FIGS. 9 and 10, the radiation image storage panel comprises a support 41, a sealing frame 42, a phosphor layer 43, a first adhesive layer 44, a moisture-proof protective film 45, a second adhesive layer 46, and a reinforcement means 47. In the support 41, an airway 41a and an air-buffer 41b are formed. There is a gap 48 between the sealing frame 42 and the phosphor layer 48.

### COMPARISON EXAMPLE 1

The procedure of Example 1 was repeated except for not providing the reinforcement means, to produce a radiation image storage panel for comparison.

[Evaluation of Radiation Image Storage Panel]

The produced radiation image storage panels were evaluated on the basis of the peel strength test described below.

The peel strength of the storage panel prepared in Example 1 was measured in the following manner. On the corner of the reinforcement means, an aluminum plate (length: 10 mm, width: 5 mm, thickness: 1 mm) was partly glued with epoxy adhesive so that a half of the plate (namely, 5 mm in length) was overhung. A wire rope was made to catch on the overhanging part of the plate, and pulled by means of the tensile tester (portable tester: ET TEST, available from Shimadzu Seisakusho Ltd.) to measure the tensile strength when the reinforcement began to peel off. On the other hand, for measuring the peel strength of the panel produced in Comparison Example 1, an adhesive tape (Nichiban Co., Ltd., length: 15 mm, width: 5 mm) was partly stuck on the corner of the protective film so that 5 mm of the tape was in contact with the layer (namely, the remainder in 10 mm length was free). The remainder was then pulled by means of the tensile tester to measure the tensile strength when the protective film began to peel off.

As a result, the peel strength of the reinforcement means provided on the panel of Example 1 was 0.98 kg, while that of the protective film provided on the panel of Comparison Example 1 was 0.11 kg. The result clearly indicates that a radiation image storage panel of the invention (Example 1), which is equipped with the reinforcement means, was improved in the peel strength as compared with the storage panel without the reinforcement means (Comparison Example 1).

What is claimed is:

1. A radiation image storage panel comprising a support, a sealing frame provided on a surface of the support in a peripheral area thereof, a phosphor layer formed inside the sealing frame, and a moisture-proof protective film provided on the phosphor layer and sealing frame, wherein a reinforcement means is fixed onto a upper surface of the moisture-proof protective film at least in the area where the protective film covers the sealing frame.

2. The radiation image storage panel of claim 1, wherein a gap is formed between the sealing frame and the phosphor layer, and the reinforcement means is fixed onto the upper surface of the moisture-proof protective film in the area where the protective film covers both the sealing frame and the gap.

3. The radiation image storage panel of claim 1, wherein the reinforcement means is made of material which is more rigid than material of the moisture-proof protective film.

4. The radiation image storage panel of claim 1, wherein the reinforcement means is made of material equivalent to material of the sealing frame.

5. The radiation image storage panel of claim 1, wherein the reinforcement means is made of metal.

6. The radiation image storage panel of claim 1, wherein the phosphor layer is formed by vapor deposition.

7. A radiation image storage panel comprising a support, a phosphor layer provided thereon and in an area other than a peripheral area of the support, and a moisture-proof protective film covering the phosphor layer whose hem is fixed via an adhesive layer onto the support in the peripheral area; wherein a reinforcement means is fixed onto a upper surface of the moisture-proof protective film at least in the area where the protective film covers the peripheral area.

8. The radiation image storage panel of claim 7, wherein the reinforcement means is made of material which is more rigid than material of the moisture-proof protective film.

9. The radiation image storage panel of claim 7, wherein the reinforcement means is made of material equivalent to material of the support.

10. The radiation image storage panel of claim 7, wherein the reinforcement means is made of metal.

11. The radiation image storage panel of claim 7, wherein the phosphor layer is formed by vapor deposition.
